(19) United States
(12) Patent Application Publication
(10) Pub. No.: US 2025/0265103 A1
(43) Pub. Date: Aug. 21, 2025

(54) SYSTEMS AND METHODS FOR LEGACY APPLICATION MIGRATION AND DEPLOYMENT AUTOMATION

(71) Applicant: Kemper Corporate Services, Chicago, IL (US)

(72) Inventors: Alok Mehta, Winnetka, IL (US); William B. Awad, Chicago, IL (US); Russel W. Langel, St. Augustine, FL (US); Daniel M. Jaffa, St. Johns, FL (US); Javed Husain, Winfield, IL (US); Shravan Kumar Chitty, Aurora, IL (US); Partha Dash, Melissa, TX (US); Greg Olds, St. Louis, MO (US); James Mimbs, St. Augustine, FL (US); Charles K. Smith, Jacksonville, FL (US)

(21) Appl. No.: 18/442,896

(22) Filed: Feb. 15, 2024

(51) Int. Cl. G06F 9/455; G06F 11/14; G06F 11/36

(52) U.S. Cl. CPC G06F 9/455; G06F 11/1448; G06F 11/3688

(57) ABSTRACT

The disclosure comprises systems and methods for migrating an application between platforms, the method comprising identifying a legacy application for transfer from a legacy mainframe to an enterprise platform. The method can include determining legacy data associated with the legacy application. The method can include receiving the legacy data and the legacy application into the enterprise platform. The method can include determining a classification of the legacy application. The method can include implementing an emulator application wherein the emulator application is configured to generate at least one integration application associated with the classification of the legacy application. The method can further include generating an enterprise application on the enterprise platform based on the legacy data, the legacy application, and the classification of the legacy application.

### TECHNICAL FIELD

The present disclosure generally relates to conversion of legacy APIs and more particularly to generating new APIs on other party platforms.

### BACKGROUND

Legacy application program interfaces (API) are an essential component in system software architecture. In one aspect, these legacy APIs may be configured to process under the confines of a particular hardware server. However, as many current APIs are processed in cloud-based environments, the restrictions implicit to legacy applications diminish the continual and ongoing viability of these applications. Even though it may be efficient to remove the legacy APIs from general usage, their functionality and usage may still be applicable.

### BRIEF SUMMARY

The subject disclosure provides for systems and methods for migrating legacy applications to other environments and generating applications in other environments. One aspect of the present disclosure relates to a method of integrating legacy applications into an enterprise platform. The method may include migrating an application between platforms through identifying a legacy application for transfer from a legacy mainframe to an enterprise platform. Identifying the legacy application defines the planning and preparation needed to reduce the technical debt comprising the project cost and implementation complexity. The method can also include determining legacy data associated with the legacy application. Determining the legacy data involves understanding the scope of data and the associated requirements such that there is minimal data loss or corruption during transfer. The method can comprise determining a classification of the legacy application. Classifying the legacy application helps in understanding its role, dependencies, and requirements within the new platform. This classification guides how the application will be integrated and used in the new environment. Additionally, the method can include implementing an emulator application wherein the emulator application is configured to generate at least one integration application associated with the classification of the legacy application. This emulator is tailored to generate one or more integration applications based on the legacy application's classification. The emulator is implemented to mimic the environment of the legacy system within the enterprise platform. Furthermore, the method can include receiving the legacy data and the legacy application into the enterprise platform. In addition, the method can comprise generating an enterprise application on the enterprise platform based on the legacy data, the legacy application, the integration application, and the classification of the legacy application. Each of these characteristics are used to aid the new application to function effectively in the new environment, leveraging the capabilities and features of the enterprise platform.

Another aspect of the present disclosure relates to a system configured for migrating legacy applications to other environments. The system may include one or more hardware processors configured by machine-readable instructions. The processor(s) may be configured to migrate an application, to identify a legacy application for transfer from a legacy mainframe to an enterprise platform, to determine legacy data associated with the legacy application, to receive the legacy data and the legacy application into the enterprise platform. The system can comprise an emulator wherein the emulator comprises an emulator application configured to generate at least one integration application associated with the classification of the legacy application to determine a classification of the legacy application, and/or to generate an enterprise application on the enterprise platform based on the legacy data, the legacy application, the at least one integration application, and the classification of the legacy application.

Yet another aspect of the present disclosure relates to a non-transient computer-readable storage medium having instructions embodied thereon, the instructions being executable by one or more processors to perform a method for migrating legacy applications. The method can comprise identifying a legacy application for transfer from a legacy mainframe to an enterprise platform. The method can include determining a classification of the legacy application. Additionally, the method can include implementing an emulator application wherein the emulator application is configured to generate at least one integration application associated with the classification of the legacy application. Furthermore, the method can include determining legacy data associated with the legacy application; receiving the legacy data and the legacy application into the enterprise platform. The method can further include generating an enterprise application on the enterprise platform based on the legacy data, the legacy application, the at least one integration application, and the classification of the legacy application.

Still another aspect of the present disclosure relates to a method for automating a build and deployment of an application on a third-party platform. The method can include identifying source code from a repository or other storage device. The method can include receiving a plurality of parameters, wherein the plurality of parameters define an application architecture for deployment into a platform. In response to receiving the parameters, the method can include generating application consistent with an environment operable on the platform.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system configured to migrate legacy applications, in accordance with one or more implementations.

FIG. 2 illustrates a flowchart configured to migrate legacy applications, in accordance with one or more implementations.

FIG. 3 illustrates a flowchart for migrating legacy applications, in accordance with one or more implementations.

FIG. 4 illustrates a system configured to migrating and automatically generating applications, in accordance with one or more implementations.

FIG. 5 illustrates a method for migrating applications, in accordance with one or more implementations.

FIG. 6 illustrates a method for automatically generating applications, in accordance with one or more implementations.

FIG. 7 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

This disclosure seeks to streamline and automate various processes to achieve advantages including improved efficiency, reduced errors, and significant time savings when managing and maintaining legacy applications. Legacy applications are applications that maintain viability for business purposes but their inherent architecture may no longer be suitable for operation on a particular platform. This system and process also provides a plurality of technical advantages with respect to managing and integrating legacy applications. For example, the disclosure can reduce cost by eliminating use of expensive software and computational effort. Transitioning legacy applications to a cloud platform integrates agility with improved time to market (ex: increased number of releases in a calendar year.) In a further aspect, the cloud platform can be referred to as the enterprise platform or final destination for the migrated application. Migrating the applications to a cloud platform also increases the availability of talent in the market to support the system because maintaining legacy technology software can require a skill set that is not readily available. The disclosure improves transparency on costing by monitoring a dashboard on resource usage. The application is scalable for business growth with minimal changes and improves monitoring for faster resolutions. In yet a further aspect, the manner of migration and automation as disclosed provides easier maintenance of infrastructure components as application within a Configuration Management Database (CMDB) is linked to BAPPD, an identification used to find entries in the CMDB. During migration the CMDB supports internet technology (IT) processes including incident management, problem resolution and change management. These IT supportive processes by the CMDB can enhance decision-making and operational efficiency.

To facilitate the migration of the legacy applications, the disclosure includes additional components to ensure that converted legacy APIs function properly on the new platform, such as a cloud environment. These integrations are uniquely developed to allow a mainframe emulator to work in the cloud environment. Without these integration applications provided by the mainframe emulator, the legacy applications cannot be migrated. Further, these integrations can also be automated, wherein the disclosure further details an automation of certain features. The first automation feature comprises automating the migration of the legacy applications to a cloud-based environment (enterprise platform). The second automation feature focuses on automating application builds via the mainframe emulator.

Legacy applications and/or coding that resides in older platforms can still have viability. The disclosure provides a system and method to convert data and migrate the application to a current platform. For example, the migration can transition to a cloud platform, such as AMAZON WEB SERVICES® (AWS). In preparation for migration, a particular application can be grouped into a category. The category can determine the requirements needed to perform a migration on the application. Further, the migration categories can include: rehosting, re-platform, re-architecting, retiring, and co-location. A rehosting implementation requires a lift and shift of the application logic as-is from one platform to another. For example, the application may have a plurality of integration touch points but does not have a suitable user interface. Integration touch points comprise specific points or interfaces where the legacy application interacts or connects with other systems, applications, or services. These touch points can define how the application is integrated into the broader IT ecosystem and for ensuring seamless functionality post-migration. In a migration scenario, especially in rehosting, identifying these touch points can be used to determine where to initiate maintenance or adaptation of connections in the new environment, such as a cloud platform. This ensures that the migrated application continues to communicate effectively with other systems, preserving its operational integrity and functionality.

The re-platform implementation can be used when most of the application logic is made to work on a new platform while requiring less computational resources. A re-platform may be used when the overall usage is limited from accessing historical static data. Re-architecting an application can be used when the underlying software architecture is unsupported by technology. When an application is retired, the application is not in use and the underlying business functionality can be accessed from other applications, allowing the application to be replaced with a new application or product. Finally, a co-located implementation occurs when the architecture of the application may not be supported in the cloud platform.

Once applications are grouped along with the file touch points across the applications, the migration of the application can be initiated by licensing the application from the legacy mainframe to the Amazon mainframe (AMF). File touch points can include specific points of interaction or connection between a legacy application and other systems, files, or processes within the IT infrastructure. During the migration of legacy applications to a new platform like an Amazon mainframe, identifying these touch points has value. In particular, the file touch points represent the areas where the application integrates with and accesses external resources, such as databases, file systems, or other applications. Properly managing these touch points ensures that the application maintains its functionality and integration capabilities in the new environment. Further, the legacy applications can be migrated to the an enterprise mainframe (such as Amazon mainframe) via multiple processes. In one embodiment, the legacy application can be migrated in an incremental approach. In the incremental approach, a progressive series of legacy applications can be run in the legacy mainframe and the Amazon mainframe. For example, if there are fifty (50) legacy applications, under the incremental approach, a first application of the fifty applications can be run in both the legacy mainframe and Amazon mainframe. The results of running the applications in both environments can be compared. The process can proceed from the initial legacy application to the second legacy application, repeating until all 50 legacy applications have been processed in both environments. With the incremental approach, defects can easily be tracked; time taken by jobs in production can be tracked. In addition, the flexibility gained from the ability to track defects and job time allows for more efficient release of new environments and architecture developments.

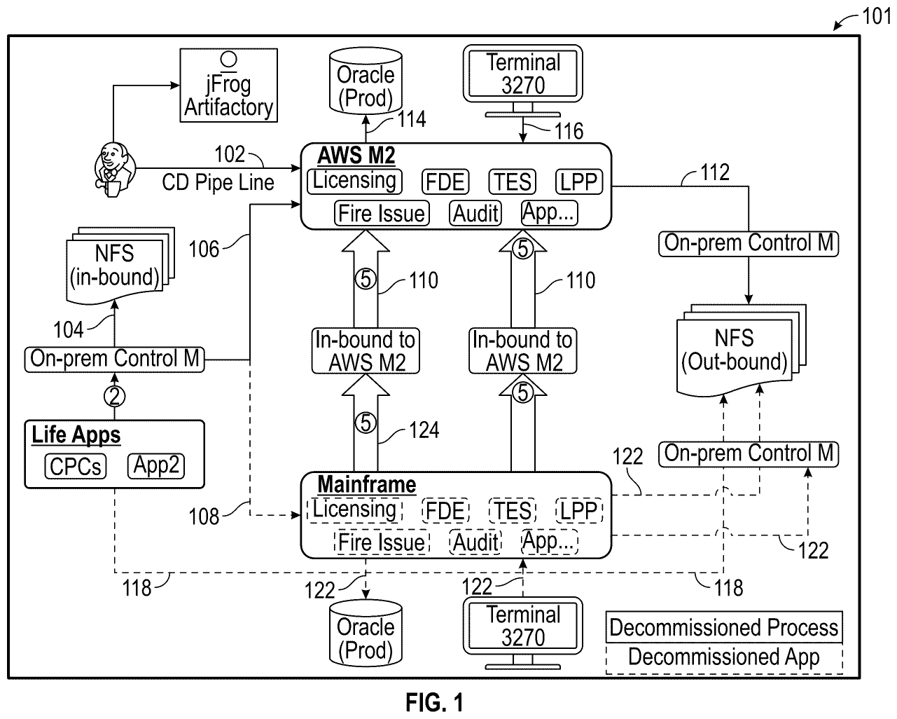

In the second migration approach, a grouping approach can be used. Similar to the incremental approach, the migration can initiate with 50 legacy applications, all 50 applications can be run on the legacy mainframe and the 50 applications would be run on the Amazon mainframe. The results can then compared after all the applications are run. In the grouping approach, a file transfer may not be needed. A data integrity check can be surpassed for Amazon mainframe files. The grouping approach also generates a production type environment consistent with business environments. In the grouping approach, as further depicted in the exemplary embodiment of FIG. 1, an opensource plugin, such as JENKINS®, can be used to deploy binaries of legacy applications to the cloud platform. While on the cloud platform, incoming feed files from the legacy application can be processed, resulting in replacing the legacy mainframe processes. As depicted in FIG. 1, the flow chart 100 depicts an exemplary system 101. In step 102, Jenkins can pull data in the form of binaries and/or jobs from Artifactory and deployed to AWS mainframe modernization (M2). Post deployment to the AMF, additional steps can be executed. In step 104, application systems (i.e., commission calculation application (CPCS), etc.) can send a feed to the network filing system (NFS). At step 106, once a file is received from a repository, control jobs on the enterprise platform (e.g., the AMF) can be invoked. At step 108, jobs on the legacy Mainframe can be decommissioned and the legacy Mainframe applications may not consume a feed file from the control jobs. At step 110, a transfer of all virtual storage (VSAM) and input files is completed from Legacy Mainframe to AMF. At step 112, outbound feeds to Life apps/reporting apps can be sent from AMF. At step 114, outbound feeds to update the on premise database can be received from AMF. At step 116, a user can access the migrated business application on the enterprise platform (AMF) through terminal 3270 which will be re-configured to point to AMF. At step 118, Life apps can consume the data that is generated from AMF. At step 120, connectivity of database, 3270 terminal, NFS folder with Mainframe apps will be decommissioned. At step 124, once application in enterprise mainframe (e.g., Amazon Mainframe) gets stabilized, the Mainframe apps will be decommissioned.

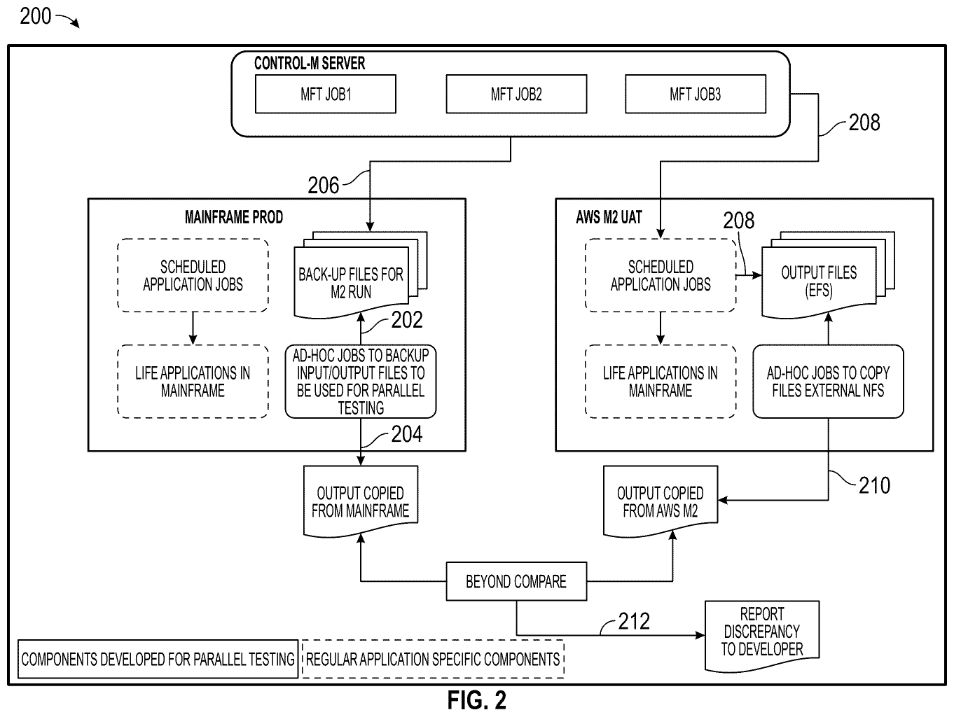

As mentioned earlier, the results from jobs generated from the migrated legacy applications can be verified as depicted in FIG. 2, in process 200. In step 202, Ad-hoc jobs can be developed to copy and back-up the input files that are needed to execute the jobs in AWS. In step 204, output files generated from Mainframe jobs can be copied to a NFS folder for comparison purposes. At step 206, legacy jobs, such as managed file transfer (MFT) jobs, are developed to read files from Mainframe back direct access storage device (DASD) volume. At step 208, the enterprise platform (e.g., AWS platform) can consume the input file and generate the output that will be stored in an Amazon Elastic File System EFS. At step 210, the Ad-hoc jobs can copy the output file from EFS to a NFS folder. At step 212, a tester function can use comparison tool (e.g. Beyond Compare) to compare the output files generated from Mainframe and AWS. In one aspect, the comparison tool can visually contrast and merge differences between text files, folders, source code, and even images or data files, highlighting discrepancies with color coding. Any discrepancies can be notified to a Developer and the results inform the developer how effective and accurate the migration process is.

Beyond verifying the accuracy of transactions, the migration process to the AWS platform requires certain integration applications/plug-ins to integrate the legacy applications into the platform. In one embodiment, the integration can be facilitated with an emulator. Here the emulator is an auxiliary software application on the cloud platform (e.g., The Amazon webservice) to run software originally configured to run on the legacy mainframe or using legacy software architecture. For the emulator to function, additional applications were developed to allow the mainframe emulator to work in the cloud environment (AWS platform); without these integration applications, the legacy applications cannot be migrated with full functionality on the AWS platform. Further, these integrations can also be automated.

The emulator can address functionalities including but not limited to printing, batch job performance, parallel testing, assembler conversion, and an SQL loader for usage with databases. In conjunction with Microfocus to streamline SQL connections, a wrapper program can execute SQLLDR (SQL*Loader) from batch. This improvement enhances code maintainability and extends the solution to non-mainframe applications. Regarding assembly language, an intermediate assembler can be generated to convert the assembly language to a higher-level language such as Cobol to continue the migration activity. To address mail issues, the emulator can operate in conjunction with other programs (Microfocus) to simplify the sending of emails from batch jobs. This solution includes functions for converting TXT to RTF, maintaining compatibility without significant changes to existing processes.

In a further aspect, the emulator can include a secure file transfer solution. This functionality facilitates the secure transmission of files between various sources, including mainframes and NFS systems. This implementation enhances data security and offers extensibility for future use across the enterprise. In a further aspect, the secure file transfer can utilize Microfocus's MFSFTP. The emulator further comprises a custom print exit solution, addressing the challenge of migrating from a solution dependent on third-party software (QTP) to a format compatible with the AWS M2 platform. As a result, the emulator can ensure continued compatibility between applications and efficient printing capabilities. Further, the emulator can reduce technical debt, directly related to an increased cost and increased complexity of a project stemming from rushed development, inadequate documentation and using outdated technology, by streamlining job scheduling, monitoring, and management, improving overall efficiency in task execution. In one aspect, the emulator can take daily incremental back-ups of enterprise server configuration, application, and system data. The emulator can improve RPO (Recovery Point Objective) and RTO (Recovery Time Objective) for all applications.

In another aspect, the emulator can be configured to enhance security protocols in the migration of applications. For example, security enhancements have been applied to a Terminal 3270 as depicted in FIG. 1, ensuring that all requests from Terminal 3270 are encrypted with TLS (Transport Layer Security) 1.2. This encryption safeguards data integrity during transmission, enhancing overall security. The emulator also streamlines the security approach by decoupling internet technology (IT) systems by separating components such as applications, services, or databases so that they operate independently, the authentication and authorization steps, reducing the impact on mission-critical systems. Authentication can now leverage the Kemper domain Active Directory, while authorization is managed through a Federated AWS Directory Server Managed AD, ensuring that user roles and permissions are maintained without overburdening the primary system.

In particular, decoupling enhances resilience and security because more targeted management and protection of each component can be used. For example, when systems are decoupled, the failure or malfunctioning of one component does not directly impact the others. This isolation ensures that mission-critical systems remain stable and operational even if one part of the broader system encounters issues. Further, security breaches can also be isolated and less likely to spread to other parts of the system. With decoupled systems, security protocols can be tailored to the specific needs and vulnerabilities of each component, rather than relying on a one-size-fits-all approach. Decoupled systems can be monitored and maintained more effectively. Updates, patches, and security improvements can be implemented on individual components without disrupting the entire system.

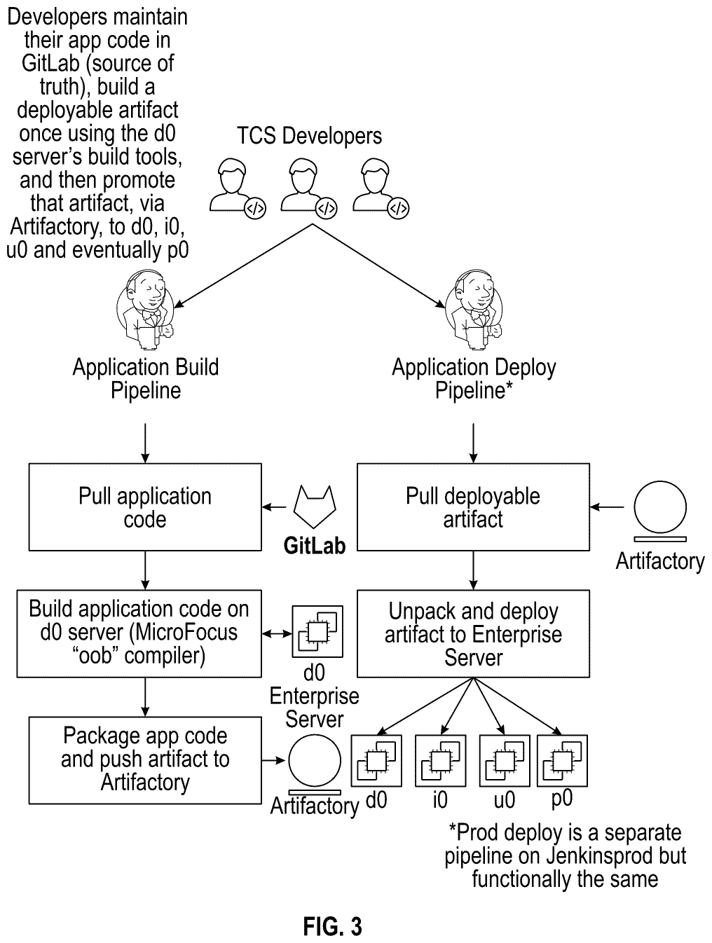

The disclosure can also be configured to automate a legacy application migration as well as automatically build an application on the enterprise platform. Both automation processes can flow through pipelines facilitated by a continuous integration and continuous delivery/continuous deployment (CI/CD) tool, such as Jenkins. As depicted in FIG. 3, the build automation can be facilitated via the CI/CD tool and can be implemented on an automated CI/CD platform, such as GITLAB®. During the build process, application code for the desired application can be pulled from a source depository. The application can be built on an auxiliary enterprise server and be provided back to the build pipeline. The built application can be packaged and pushed to the cloud platform. In a further aspect, the build pipeline can automate a “scripted build” process supplied by AWS using a compiler utility. The scripted build can be further defined by proving build parameters, such that the build parameters can define the software architecture for the application. As depicted in FIG. 3, the enterprise server can be used as an application build machine. In other instances, slave machines to the enterprise server can be created to take processing loads off the enterprise server. After the applications have been built on the enterprise platform (AWS), the generated application can be controlled by a management application, such as ARTIFACTORY®. The management application can function as a hosting, managing, and distributing binaries and artifacts. For example, a user/developer would have ability to provide parameters such as the account, the application name, and the environment. In addition, the initial setup of the automation may require identifying a root repository that may store an environmental variable, COBOL source files for a batch compiler.

As also depicted in FIG. 3, the cloud platform can comprise an automation deployment pipeline to facilitate applications migrating from legacy applications/servers. In the deployment pipeline, the migrated application can be pulled on to the cloud platform with the management platform. While on the cloud platform, the migrated application can be unpacked and deployed onto an enterprise server functioning on the cloud platform. During the deployment process, the user/developer can initially select deployment parameters including the account, application name, environment, version, and the build number. The build number contains the configuration for automating a specific task or step in the application building process. These tasks include gathering dependencies, compiling, archiving, or transforming code, and testing and deploying code in different environments.

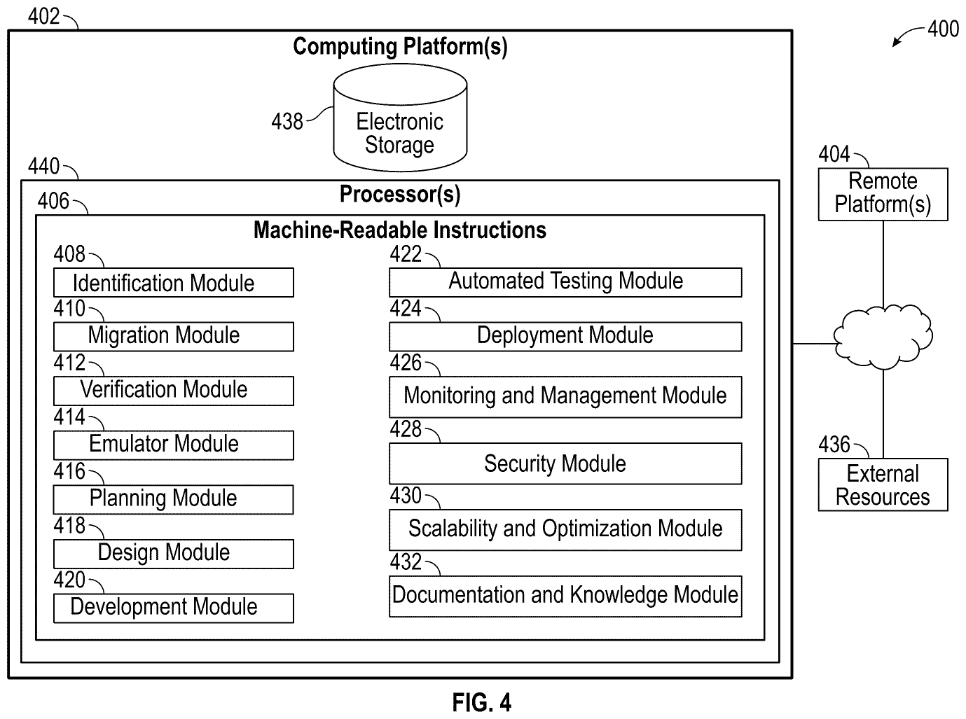

FIG. 4 illustrates a system 400 configured for migrating legacy applications, in accordance with one or more implementations. In some implementations, system 1600 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction modules may include computer program modules. The instruction modules may include one or more of an identification module 408, migration module 410, verification module 412, emulator module 414, planning module 416, design module 418, development module 420, automated testing module 422, deployment module 424, monitoring and management 426, security module 428, scalability and optimization module 430, documentation and knowledge module 432, and/or other instruction modules.

An identification module 408 may be configured to determine the legacy API for migration. A migration mode module 410 may be configured to determine that the legacy API will be migrated in a batch mode or an online mode. A verification module 412 may be configured to compare the data results operating through the enterprise platform against data results generated by the legacy API operating in the legacy API's originating legacy environment. The emulator module 414 can comprise a plurality of submodules that streamline and also permit legacy applications and data to run in the cloud platform. The emulator module 414 can facilitate the secure transmission of files between various sources, including mainframes and NFS systems. The emulator module 414 can comprise a SQL loader feature to stream SQL connections to enhance code maintainability and extend the solution to non-mainframe applications. The emulator module 414 can be configured to execute a custom print exit solution, addressing the challenge of migrating from a solution dependent on third-party software (QTP) to a format compatible with the AWS M2 platform. The emulator module 414 can be configured to manage jobs in the cloud platform. The emulator module can also be configured to manage security protocols during migration.

The planning module 416 can be configured to define the scope, objectives, and success criteria of the migration project. In a further aspect, the planning module can be configured to identify the mainframe application's components and dependencies. In yet a further aspect, the planning module can be configured to generate a migration strategy comprising determining the software architecture to be implemented on the enterprise platform (AWS) and resource allocation.

The design module 418 can be configured to design the cloud architecture for the enterprise platform based on best practices and the application's requirements. Further, the design module generates infrastructure as code (IaC) using add-ins associated with the third-party platform. For example, the design module 418 can implement AWS CloudFormation to automate resource provisioning.

The development module 420 can be configured to refactor or rewrite mainframe code from implementation in the cloud and/or the enterprise platform. The development module can develop microservices, APIs, or containerized applications that aligned with the third-party (AWS) auxiliary services. The development module 420 can be further configured to implement continuous integration (CI) and version control to enable automated testing and deployment.

The automated testing module 422 can be configured to determine automated testing frameworks for unit, integration, and acceptance testing. The automated testing module 422 can be configured to use testing add-ins for the automated build and test processes. Examples of tools to implement the build can include AWS CodePipeline and AWS CodeBuild. In a further aspect, the automated testing module 422 can be configured to implement performance and security testing to ensure the application met requirements.

The deployment module 424 can be configured to automate the deployment process. In one aspect, the deployment process can comprise using CI/CD pipelines to move code through development, testing, and production stages. In a further aspect, the deployment module can comprise utilizing blue-green or canary deployment strategies for minimal downtime and risk. An Add-in to implement the deployment module 424 can include Leveraged AWS CodeDeploy.

The monitoring and management module 426 can be configured to implement cloud-native monitoring. The module can integrate other APIs for monitoring; for example, using AWS CloudWatch and AWS CloudFormation for infrastructure management and updates. Further, the monitoring and management module can set up alarms and notifications to detect and respond to issues promptly.

The security module 428 can be configured to implement security measures such as identity and access management (IAM), encryption, and network security groups. In an aspect, the security module 428 ensures compliance with industry standards and regulations relevant to the application.

The scalability and optimization module 430 can be configured to leverage auto-scaling and load balancing to handle varying workloads efficiently. The scalability and optimization module 430 can be further configured to monitor application performance and optimized resources for cost savings.

The documentation and knowledge sharing module 432 can be configured to generate a comprehensive documentation for the automated software development life cycle process, architecture, and deployment procedures.

In some implementations, computing platform(s) 402, remote platform(s) 404, and/or external resources 436 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 436 may be operatively linked via some other communication media.

A given remote platform 404 may include one or more processors configured to execute computer program modules. The computer program modules may be configured to enable an expert or user associated with the given remote platform 404 to interface with system 400 and/or external resources 436, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms.

External resources 436 may include sources of information outside of system 400 and 1700, external entities participating with system 400, and/or other resources. In some implementations, some or all of the functionality attributed herein to external resources 436 may be provided by resources included in system 400.

Computing platform(s) 402 may include electronic storage 438, one or more processors 440, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 438 may comprise non-transitory storage media that electronically stores information. The electronic storage media of electronic storage 438 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 438 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 438 may include one or more virtual storage resources (e.g., cloud storage, a virtual private network, and/or other virtual storage resources). Electronic storage 438 may store software algorithms, information determined by processor(s) 440, information received from computing platform(s) 402, information received from remote platform(s) 404, and/or other information that enables computing platform(s) 402 to function as described herein.

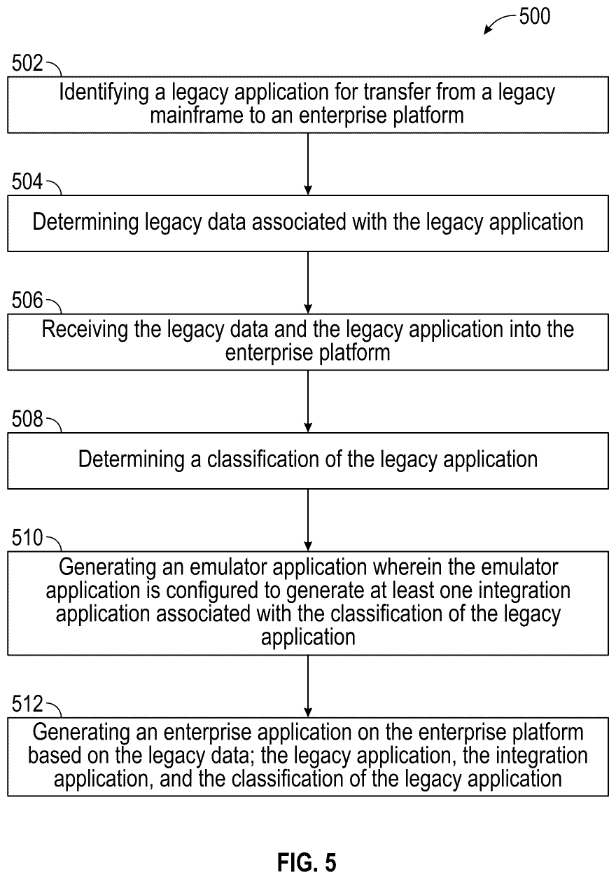

Processor(s) 440 may be configured to provide information processing capabilities in computing platform(s) 402. As such, processor(s) 440 may include one or more of a digital processor, an analog processor, a digital circuit designed to process information, an analog circuit designed to process information, a state machine, and/or other mechanisms for electronically processing information. Although processor(s) 440 is shown in FIGS. 4 and 5 as a single entity, this is for illustrative purposes only. In some implementations, processor(s) 440 may include a plurality of processing units. These processing units may be physically located within the same device, or processor(s) 440 may represent processing functionality of a plurality of devices operating in coordination. Processor(s) 440 may be configured to execute modules 408, 410, 412, 414, and/or other modules. Processor(s) 440 may be configured to execute modules 408, 410, 412, 414, and/or other modules by software, hardware, firmware, some combination of software, hardware, and/or firmware, and/or other mechanisms for configuring processing capabilities on processor(s) 440. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, 418, 420, 422, 424, 426, 428, 430, 432, and/or 434 are illustrated in FIG. 4 as being implemented within a single processing unit, in implementations in which processor(s) 440 includes multiple processing units, one or more of modules 408, 410, 412, 414, 416, 418, 420, 422, 424, 426, 428, 430, 432, and/or 434 may be implemented remotely from the other modules. The description of the functionality provided by the different modules 408, 410, 412, 414, 416, 418, 420, 422, 424, 426, 428, 430, 432, and/or 434 described below is for illustrative purposes, and is not intended to be limiting, as any of modules 408, 410, 412, 414, 416, 418, 420, 422, 424, 426, 428, 430, 432, and/or 434 may provide more or less functionality than is described. For example, one or more of modules 408, 410, 412, 414, 416, 418, 420, 422, 424, 426, 428, 430, 432, and/or 434 may be eliminated, and some or all of its functionality may be provided by other ones of modules 408, 410, 412, 414, 416, 418, 420, 422, 424, 426, 428, 430, 432, and/or 434. As another example, processor(s) 440 may be configured to execute one or more additional modules that may perform some or all of the functionality attributed below to one of modules 408, 410, 412, 414, 416, 418, 420, 422, 424, 426, 428, 430, 432, and/or 434.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

FIG. 5 is an example flow (e.g., process) for migrating applications from a legacy platform to an enterprise platform. For explanatory purposes, the example process 500 is described herein with reference to FIG. 4. At step 502, process 500 can include determining legacy data associated with the legacy application. At step 504, process 500 can include receiving the legacy data and the legacy application into the enterprise platform. At step 506, the process can include receiving the legacy data and the legacy application in the enterprise platform. At step 508, the process 500 can include determining a classification of the legacy application. At step 510, the process can include implementing an emulator application wherein the emulator application is configured to generate at least one integration application associated with the classification of the legacy application. At step 512, the process 500 can include generating an enterprise application on the enterprise platform based on the legacy data, the legacy application, and the classification of the legacy application.

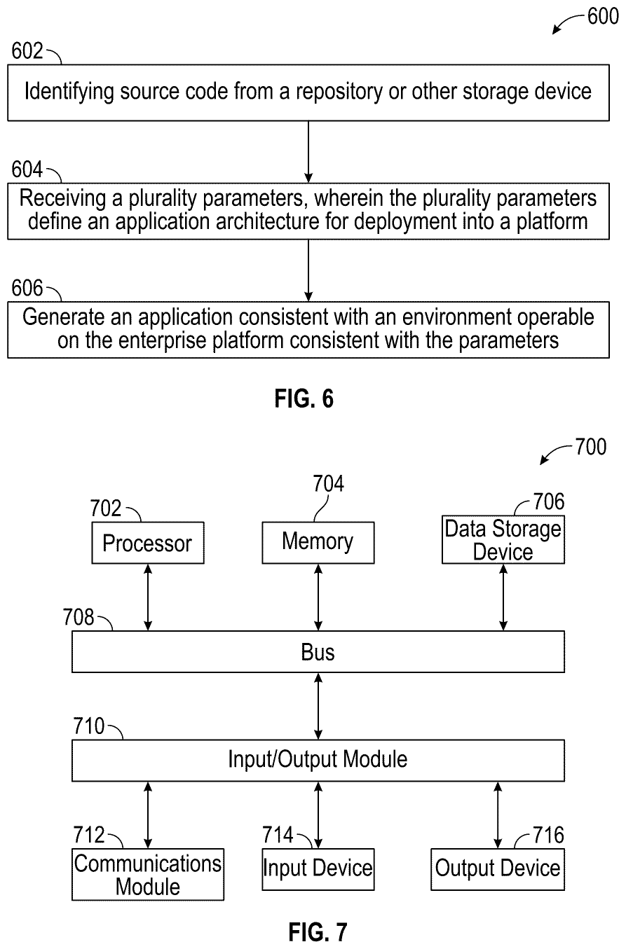

FIG. 6 is an example flow (e.g., process) for automating the generation of an application in the enterprise platform. For explanatory purposes, the example process 600 is described herein with reference to FIG. 4. At step 602, the process 600 can include identifying source code from a repository or other storage device. At step 604, the process can include receiving a plurality of parameters, wherein the plurality of parameters define an application architecture for deployment into a platform. At step 606, in response to receiving the parameters, the process 600 can generate an application consistent with an environment operable on the enterprise platform consistent with the parameters.

FIG. 7 is a block diagram illustrating an exemplary computer system 700 with which aspects of the subject technology can be implemented. In certain aspects, the computer system 1800 may be implemented using hardware or a combination of software and hardware, either in a dedicated server, integrated into another entity, or distributed across multiple entities.

Computer system 700 (e.g., server and/or client) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java,.NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described systems can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

Additionally, data from the memory 704 servers accessed via a network the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method for migrating an application between platforms, the method comprising:
identifying a legacy application for transfer from a legacy mainframe to an enterprise platform;
determining legacy data associated with the legacy application;
receiving the legacy data and the legacy application into the enterprise platform;
determining a classification of the legacy application;
implementing an emulator application wherein the emulator application is configured to generate at least one integration application associated with the classification of the legacy application; and
generating an enterprise application on the enterprise platform based on the legacy data; the legacy application, the at least one integration application, and the classification of the legacy application.

2. The method of claim 1,wherein the emulator being configured to implement incremental back-ups of at least one of an enterprise application, and enterprise system data.

3. The method of claim 1, wherein the emulator is further configured to implement an encryption protocol.

4. The method of claim 1, wherein the emulator is configured to host an application management application.

5. The method of claim 1, further comprising:
generating a first job associated with the legacy application operating on a legacy mainframe, wherein the job yields legacy resultant data;
generating a second job with the enterprise application operating on the enterprise platform, wherein the second job yields enterprise resultant data; and
comparing the legacy resultant data to the enterprise resultant data.

6. The method of claim 5, wherein comparing the legacy resultant data to the enterprise resultant data comprises implementing a tester function.

7. The method of claim 1, wherein generating the enterprise application is automated based on providing at least one build parameter wherein the at least one build parameter is associated with an architecture of the enterprise application.

8. The method of claim 1, wherein access to the legacy application operating on the legacy mainframe is provided via a terminal, initially configured to access the legacy mainframe, wherein the terminal is directed to the enterprise platform.

9. The method of claim 1, further comprising decommissioning transmission between the legacy mainframe and the enterprise platform.

10. A system configured for migrating applications between platforms, the system comprising:
one or more hardware processors configured by machine-readable instructions to:
determine legacy data associated with a legacy application;
receive the legacy data and the legacy application into an enterprise platform;
determine a classification of the legacy application;
implement an emulator application wherein the emulator application is configured to generate at least one integration application associated with the classification of the legacy application
generate an enterprise application on the enterprise platform based on the legacy data; the legacy application, the at least one integration application, and the classification of the legacy application.

11. The system of claim 10, wherein the emulator is further configured to implement an encryption protocol.

12. The system of claim 10 wherein the one or more hardware processors are further configured by machine-readable instructions to:
generate a first job associated with the legacy application operating on a legacy mainframe, wherein the job yields legacy resultant data;
generate a second job with the enterprise application operating on the enterprise platform, wherein the second job yields enterprise resultant data; and
compare the legacy resultant data to the enterprise resultant data.

13. The system of claim 12, wherein comparing the legacy resultant data to the enterprise resultant data comprises implementing a tester function.

14. The system of claim 10, wherein the enterprise application is automated based on providing at least one build parameter wherein the at least one build parameter is associated with an architecture of the enterprise application.

15. The system of claim 10, wherein access to the legacy application operating on the legacy mainframe is provided via a terminal, initially configured to access the legacy mainframe, wherein the terminal is directed to the enterprise platform.

16. The system of claim 15, further comprising decommissioning transmission between a the legacy mainframe and the enterprise platform.

17. A non-transient computer-readable storage medium having instructions embodied thereon, the instructions being executable by one or more processors to perform a method for migrating an application between platforms, the method comprising:
identifying a legacy application for transfer from a legacy mainframe to an enterprise platform;
determining legacy data associated with the legacy application;
receiving the legacy data and the legacy application into the enterprise platform;
determining a classification of the legacy application;
implement an emulator application wherein the emulator application is configured to generate at least one integration application associated with the classification of the legacy application; and
generating an enterprise application on the enterprise platform based on the legacy data; the legacy application, the at least one integration application, and the classification of the legacy application.

18. The non-transient computer-readable storage medium of claim 17, wherein the emulator is further configured to implement an encryption protocol.

19. The non-transient computer-readable storage medium of claim 17, wherein the one or more hardware processors are further configured by machine-readable instructions to:
generate a first job associated with the legacy application operating on a legacy mainframe, wherein the job yields legacy resultant data;
generate a second job with the enterprise application operating on the enterprise platform, wherein the second job yields enterprise resultant data; and
compare the legacy resultant data to the enterprise resultant data.

20. The non-transient computer-readable storage medium of claim 19, wherein comparing the legacy resultant data to the enterprise resultant data comprises implementing a tester function.
